(19) United States
(12) Patent Application Publication
(10) Pub. No.: US 2007/0156778 A1
(43) Pub. Date: Jul. 5, 2007

(54) File indexer

(75) Inventors: Hassan D. Archer, Seattle, WA (US); Cory A. Hendrixson, Bellevue, WA (US); Marcus J. Russell, Bothell, WA (US); Robert C. Houser, Snoqualmie, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/326,244

(22) Filed: Jan. 4, 2006

(51) Int. Cl. G06F 17/30

(52) U.S. Cl. 707/201

(57) ABSTRACT

An indexing algorithm executes when a storage medium is coupled to a computing device. An index cache corresponding to the storage medium may exist on the computing device if the storage medium had been previously coupled to the computing device. The index cache includes the files that were stored on the storage medium the last time that the storage medium was coupled to the computing device. If the storage medium has not been modified since the previous coupling to the computing device, files in the index cache are made immediately available to a user without re-indexing any of the files on the storage medium. If the storage medium has been modified since the previous coupling to the computing device, the index cache is synchronized such that the index cache reflects the current state of the storage medium without re-indexing all of the files on the storage medium.

### BACKGROUND

An independent storage medium is commonly coupled to a computing device to expand the memory capacity of the computing device. The storage medium is a mobile device that allows a user to access files on the storage medium from whichever computing device the storage medium is coupled. The storage medium may not be uniquely identifiable. For example, the storage medium may be a flash memory device such as a universal serial bus (USB) pen drive. When the storage medium is coupled to the computing device, each file on the storage medium and any corresponding metadata are read from the storage medium. The storage medium may include a large number of files such that reading the files and any associated metadata is time consuming. The files on the storage medium are indexed on the computing device so that a user may browse the files from the computing device. However, the user is unable to access the files until the indexing process is complete. Furthermore, the user may add or remove files from the storage medium since the last time that the storage medium was coupled to the computing device. A complete re-indexing of the files and the associated metadata on the computing device to determine which files have been modified is an inefficient use of computing time.

### SUMMARY

An indexing algorithm executes when a storage medium is coupled to a computing device. An index cache corresponding to the storage medium may exist on the computing device if the storage medium had been previously coupled to the computing device. The index cache includes the files that were stored on the storage medium the last time that the storage medium was coupled to the computing device. If the storage medium has not been modified since the previous coupling to the computing device, files in the index cache are made immediately available to a user without re-indexing any of the files on the storage medium. If the storage medium has been modified since the previous coupling to the computing device, the index cache is synchronized such that the index cache reflects the current state of the storage medium without re-indexing all of the files on the storage medium.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a file indexer application may be implemented.

FIG. 2 is a conceptual diagram illustrating major functional blocks involved in indexing files stored on a storage medium when the storage medium is coupled to a computing device.

FIG. 3 illustrates a logic flow diagram for a process of indexing files stored on a storage medium when the storage medium is coupled to a computing device.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

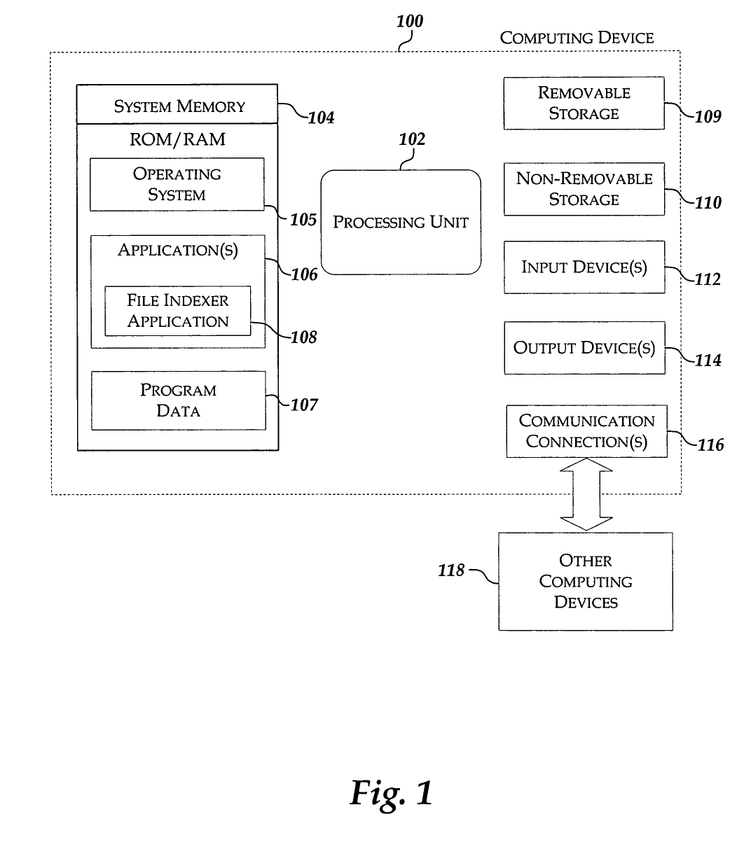

Referring to FIG. 1, an exemplary system for implementing a disk-based cache application includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include file indexer application 108 that is discussed in further detail below.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication connection(s) 116 that allow the device to communicate with other computing devices 118, such as over a network or a wireless mesh network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The present disclosure is described in the general context of computer-executable instructions or components, such as software modules, being executed on a computing device. Generally, software modules include routines, programs, objects, components, data structures, and the like that perform particular tasks or implement particular abstract data types. Although described here in terms of computer-executable instructions or components, the present disclosure may equally be implemented using programmatic mechanisms other than software, such as firmware or special purpose logic circuits.

File Indexer

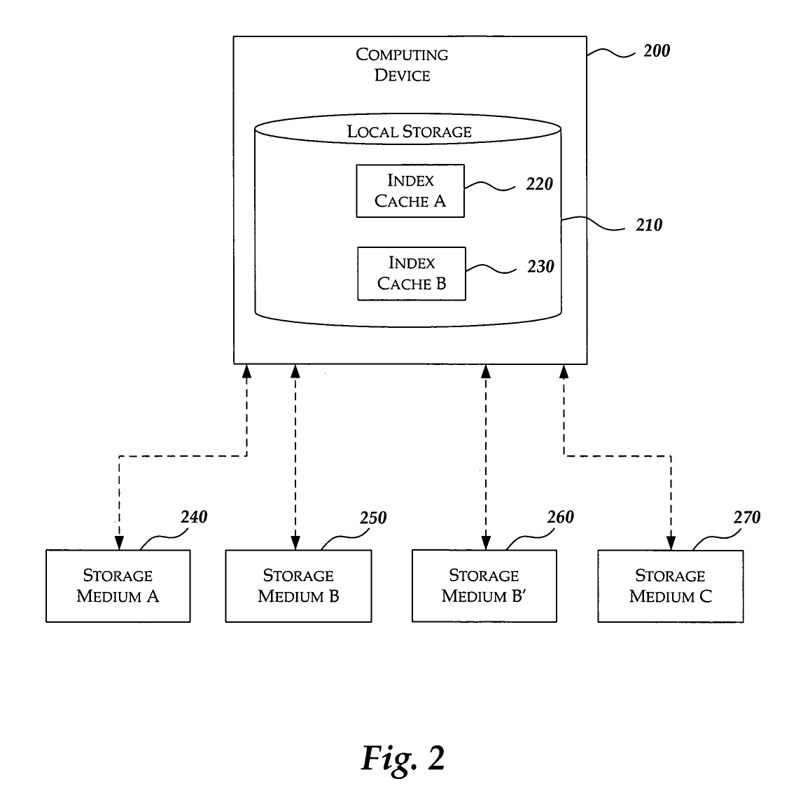

FIG. 2 is a conceptual diagram illustrating major functional blocks involved in indexing files stored on a storage medium when the storage medium is coupled to a computing device. Computing device 200 includes memory such as local storage 210. Local storage 210 may be any memory device (e.g., RAM, ROM, flash memory, etc.). Storage media may be coupled to computing device 200 to expand the memory capacity of computing device 200 such that files stored on a storage medium may be accessed from computing device 200. The files stored on the storage media may be any file type that has unique associated attributes (e.g., metadata, timestamp, etc.).

Example storage media includes storage medium A 240, storage medium B 250, storage medium B′, and storage medium C. Storage medium B′ 260 is a more recent version of storage medium B 250. In other words, the files stored on storage medium B 250 have been added, deleted, and/or modified since the last time that storage medium B 250 was coupled to computing device 200. The storage media may be any device with re-writable dynamic memory. In one embodiment, the storage media are not uniquely identifiable. For example, the storage medium may be flash memory device such as a USB pen drive. In other examples, the storage medium may be an optical device with a hard disk read/write drive, a digital media player, a camera or a communication device such as a mobile telephone.

An index cache corresponding to a storage medium is stored on local storage 210 if the storage medium had been previously coupled to computing device 200. A separate index cache may be maintained for each storage medium that has been previously coupled to computing device 200. For example, storage medium A 240 and storage medium B 250 have been previously coupled to computing device 200. Thus, corresponding index caches (e.g., index cache A 220 and index cache B 230) are stored on local storage 210.

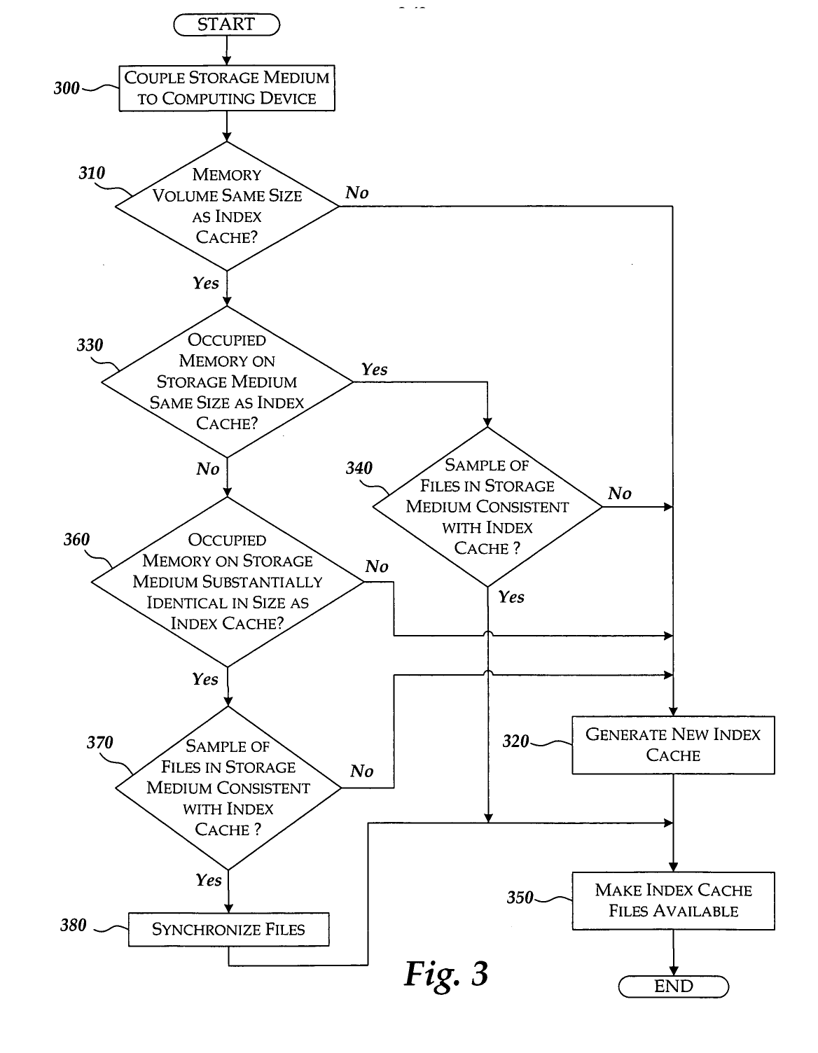

When a storage medium is coupled to computing device 200, a determination is made whether a corresponding index cache is stored in computing device 200 according to an indexing algorithm discussed in detail below in reference to FIG. 3. For example, storage medium A 240 is coupled to computing device 200. Index cache A 220 is located in computing device 200 such that the files in index cache A 220 are immediately accessible to the user. Likewise, when storage medium B 250 is coupled to computing device 200, index cache B 220 is located in computing device 200 such that the files in index cache B 220 are immediately accessible to the user.

A user may modify a storage medium since the previous time that the storage medium was coupled to computing device 200. For example, storage medium B′ 260 is coupled to computing device after an earlier version of the storage medium (i.e., storage medium B 250) was coupled to computing device 200. According to the indexing algorithm discussed in detail below with reference to FIG. 3, a determination is made that the corresponding index cache (i.e., index cache B 230) is slightly different than the files stored on storage medium B′ 260. Briefly, a determination is made about how much occupied storage space in the storage medium has changed. For example, storage medium B 250 may have 1.6 gigabytes of occupied memory while storage medium B′ 260 may have 1.7 gigabytes of occupied memory. A synchronization process is performed to update index cache B 230 to reflect the current files stored on storage medium B′ 260. The files on storage medium B′ 260 that are also stored on storage medium B 250 are not indexed again (i.e., the metadata associated with the files that are common to both storage medium B 250 and storage medium B′ 260 is not accessed). The new files that have been added to storage medium B′ 260 are added to index cache B 230 and any files that have been removed from storage medium B′ 260 are also deleted from index cache B 230. Thus, the index cache is updated to accurately reflect the modified storage medium without re-indexing all of the files on storage medium B′.

A user may couple a storage medium to computing device 200 for the first time such that a corresponding index cache is not stored in computing device 200. For example, storage medium C 270 is coupled to computing device 200 for the first time as determined according to the indexing algorithm discussed in detail below with reference to FIG. 3. Thus, a complete scan of the files on storage medium C 270 is performed to generate a corresponding index cache that is saved on computing device 200. In one embodiment, a user may radically modify a storage medium since the previous coupling to computing device 200. In this case, the storage medium is treated as if the storage medium had not been previously coupled to computing device 200 because the corresponding index cache on computing device 200 is radically different from the files stored on the storage medium. Thus, a complete scan of the radically modified storage medium is performed to generate a corresponding index cache that is stored on computing device 200.

FIG. 3 illustrates a logic flow diagram for a process of indexing files stored on a storage medium when the storage medium is coupled to a computing device. The process begins at operation 300 where a storage medium is coupled to a computing device. The storage medium may be coupled to the computing device using a wired connection (e.g., through a USB port or an insertion slot on the computing device) or wirelessly (e.g., using Bluetooth® technology).

Moving to decision operation 310, a determination is whether the total memory volume of the storage medium is the same size as an index cache stored on the computing device. For example, the storage medium may have two gigabytes of total memory. Thus, a determination is made whether a two gigabyte index cache is stored on the computing device. If the memory volume of the storage medium is the same size as an index cache that is stored on the computing device, processing continues at decision operation 330. If the memory volume of the storage medium is not the same size as an index cache that is stored on the computing device, processing moves to operation 320 where a new index cache is generated. The new index cache includes all the files stored on the storage medium. The new index cache is created because the computing device does not recognize the storage medium as having been previously coupled to the computing device. In other words, a complete scan of the files stored on the storage medium is necessary because this is the first time that the storage medium is coupled to the computing device, or a corresponding index cache that was once stored on the computing device has since been deleted or is otherwise inaccessible. The files in the new index cache are then made available to the user at operation 350. Processing then terminates at an end operation.

Continuing to decision operation 330, a determination is made whether the occupied memory on the storage medium is the same size as the occupied memory of the index cache. The index cache includes the files that were stored on the storage medium the last time that the storage medium was coupled to the computing device. The occupied memory would be the same size if no modifications have been made to the files on the storage medium since the last time that the storage medium was coupled to the computing device. If the occupied memory on the storage medium is the same size as the occupied memory of the index cache, processing continues at decision operation 340. If the occupied memory on the storage medium is not the same size as the occupied memory of the index cache, processing moves to decision operation 360.

Advancing to decision operation 340, a determination is made whether a sample of files on the storage medium is consistent with the files stored in the corresponding index cache. A random sampling of files is selected from the storage medium. An attempt is made to locate the sampled files in the index cache. In one embodiment, the sampling is time-based. For example, the consistency between the sampling and the corresponding content in the index cache is checked for up to two seconds after the storage medium is coupled to the computing device. In another embodiment, the sampling is volume-based. For example, up to fifty files are sampled. During the consistency check, a determination is made whether the sampled files correspond to files in the index cache. If each sampled file corresponds to a file in the index cache, a determination is then made whether each sampled file has the same metadata as the corresponding file in the index cache. Thus, any modifications to metadata associated with a file may be determined. For example, the sampled files may include a music file. The user may have changed the name of the artist associated with the music file such that the metadata associated with the file has been modified. If the sample of files on the storage medium is consistent with the files stored in the corresponding index cache, the storage medium is presumed to have been previously coupled to the computing device. The files in the index cache are made immediately available to the user at operation 350. Thus, a complete re-indexing of the files stored on the storage medium is avoided. Processing then terminates at the end operation. If the sample of files on the storage medium is not consistent with the files stored in the corresponding index cache, processing moves to operation 320 where a new index cache of the files stored on the storage medium is generated as described above.

Transitioning to decision operation 360, a determination is made whether the occupied memory on the storage medium is substantially identical in size to the occupied memory of the index cache. The occupied memory would be substantially identical in size if modifications have been made to the files on the storage medium since the last time that the storage medium was coupled to the computing device. In one embodiment, the occupied memory on the storage medium is considered substantially identical in size to the occupied memory of the index cache when the difference in size of the occupied memory between the storage medium and the index cache is ±15%. If the occupied memory on the storage medium is not substantially identical in size to the occupied memory of the index cache, processing continues at operation 320 where a new index cache of the files stored on the storage medium is generated as described above. If the occupied memory on the storage medium is substantially identical in size to the occupied memory of the index cache, processing continues at decision operation 370.

Proceeding to decision operation 370, a determination is made whether a sample of files on the storage medium is consistent with the files stored in the corresponding index cache as described above with reference to operation 340. If the sample of files on the storage medium is not consistent with the files stored in the corresponding index cache, processing moves to operation 320 where a new index cache of the files stored on the storage medium is generated as described above. If the sample of files on the storage medium is consistent with the files stored in the corresponding index cache, the storage medium is presumed to have been previously coupled to the computing device. Processing then continues at operation 380.

Moving to operation 380, the files in the index cache are synchronized with the files on the storage medium such that the index cache is updated to reflect the current state of the storage medium. In one embodiment, the files are synchronized by determining whether the files on the storage medium are also present in the index cache. If a file exists on the storage medium and in the index cache, the file is noted as stored in the index cache but the corresponding metadata is not accessed. An assumption is made that the metadata associated with the file in the index cache is correct such that the indexing process for a slightly modified storage medium is expedited. A file may exist on the storage medium but is not in the index cache because the file has been added to the storage medium since the previous coupling of the storage medium to the computing device. The metadata associated with the newly added file is accessed and the file is included in the index cache. After the presence of all of the files on the storage medium are verified for inclusion in the index cache, a determination is made whether any files in the index cache have been removed from the storage medium since the previous coupling of the storage medium to the computing device. Any files in the index cache that have been removed from the storage medium are also deleted from the index cache. The synchronized files in the index cache are made immediately available to the user at operation 350. Thus, a complete re-indexing of the files stored on the storage medium is avoided. The user may then browse an internal index of metadata from the computing device. Processing then terminates at the end operation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for indexing files stored on a storage medium when the storage medium is coupled to a computing device, comprising:
coupling the storage medium to the computing device;
accessing an index cache on the computing device when the storage medium has been previously coupled to the computing device, wherein the index cache comprises files that were stored on the storage medium when the storage medium was previously coupled to the computing device;
synchronizing the files in the index cache with the files on the storage medium when any of the files on the storage medium have been modified since the storage medium had been previously coupled to the computing device, wherein the index cache comprises the files that are stored on the storage medium; and
making the files available from the index cache.

2. The computer-implemented method of claim 1, further comprising determining whether the storage medium has been previously coupled to the computing device.

3. The computer-implemented method of claim 2, wherein determining whether the storage medium has been previously coupled to the computing device further comprises determining whether the memory volume of the storage medium is the same size as the memory volume of the index cache.

4. The computer-implemented method of claim 2, wherein determining whether the storage medium has been previously coupled to the computing device further comprises determining whether the occupied memory of the storage medium is the same size as the occupied memory of the index cache.

5. The computer-implemented method of claim 2, wherein determining whether the storage medium has been previously coupled to the computing device further comprises determining whether the occupied memory of the storage medium is substantially identical to the occupied memory of the index cache.

6. The computer-implemented method of claim 2, wherein determining whether the storage medium has been previously coupled to the computing device further comprises determining whether a sample of the files on the storage media correspond to files in the index cache.

7. The computer-implemented method of claim 6, wherein determining whether the sample of the files on the storage media correspond to files in the index cache further comprises matching metadata associated with the files in the sample to metadata associated with the corresponding files in the index cache.

8. The computer-implemented method of claim 6, further comprising obtaining the sample of the files from the storage media for up to a predetermined time period.

9. The computer-implemented method of claim 6, further comprising obtaining the sample of the files from the storage media for up to a predetermined number of files.

10. A system for indexing files stored on a storage medium when the storage medium is coupled to a computing device, comprising:
a computing device; and
a storage medium coupled to the computing device,
wherein the computing device is configured to:
determine whether the storage medium has been previously coupled to the computing device;
access an index cache when the storage medium has been previously coupled to the computing device, wherein the index cache comprises files that were stored on the storage medium when the storage medium was previously coupled to the computing device; and
synchronize the files in the index cache with the files on the storage medium when any of the files on the storage medium have been modified since the storage medium had been previously coupled to the computing device, wherein the index cache comprises the files that are stored on the storage medium.

11. The system of claim 10, wherein the storage medium is re-writable dynamic memory.

12. The system of claim 10, wherein the storage medium is not uniquely identifiable.

13. The system of claim 10, wherein the computing device determines whether the storage medium has been previously coupled to the computing device by determining whether the memory volume of the storage medium is the same size as the memory volume of the index cache.

14. The system of claim 10, wherein the computing device determines whether the storage medium has been previously coupled to the computing device by determining whether the occupied memory of the storage medium is the same size as the occupied memory of the index cache.

15. The system of claim 10, wherein the computing device determines whether the storage medium has been previously coupled to the computing device by determining whether the occupied memory of the storage medium is substantially identical to the occupied memory of the index cache.

16. The system of claim 10, wherein the computing device determines whether the storage medium has been previously coupled to the computing device by determining whether a sample of the files on the storage media correspond to files in the index cache.

17. The computer-implemented method of claim 16, wherein the computing device determines whether the sample of the files on the storage media correspond to files in the index cache by matching metadata associated with the files in the sample to metadata associated with the corresponding files in the index cache.

18. A computer-readable medium having computer-executable instructions for indexing files stored on a storage medium when the storage medium is coupled to a computing device, the instructions comprising:
coupling the storage medium to the computing device;
determining whether the storage medium has been previously coupled to the computing device by determining whether the memory volume of the storage medium is the same size as the memory volume of the index cache;
accessing an index cache on the computing device when the storage medium has been previously coupled to the computing device, wherein the index cache comprises files that were stored on the storage medium when the storage medium was previously coupled to the computing device;
synchronizing the files in the index cache with the files on the storage medium when any of the files on the storage medium have been modified since the storage medium had been previously coupled to the computing device, wherein the index cache comprises the files that are stored on the storage medium; and
making the files available from the index cache.

19. The computer-readable medium of claim 18, wherein determining whether the storage medium has been previously coupled to the computing device further comprises determining whether the occupied memory of the storage medium is the same size as the occupied memory of the index cache.

20. The computer-readable medium of claim 18, wherein determining whether the storage medium has been previously coupled to the computing device further comprises determining whether the occupied memory of the storage medium is substantially identical to the occupied memory of the index cache.
